(19) United States
(12) Patent Application Publication
(10) Pub. No.: US 2010/0017067 A1
(43) Pub. Date: Jan. 21, 2010

(54) METHOD AND CONTROL UNIT FOR TRIGGERING PASSENGER PROTECTION MEANS

(76) Inventors: Josef Kolatschek, Weil Der Stadt (DE); Marcus Hiemer, Meckenbeuren (DE)

Correspondence Address: KENYON & KENYON LLP, ONE BROADWAY, NEW YORK, NY, 10004, US

(21) Appl. No.: 12/304,929

(22) PCT Filed: Dec. 28, 2007
(86) PCT No.: PCT/EP2007/064616

§ 371 Date: Aug. 26, 2009

(30) Foreign Application Priority Data
Jan. 29, 2007 (DE) 10 2007 004 345.9

(51) Int. Cl. B60R 21/0136

(52) U.S. Cl. 701/46

(57) ABSTRACT

In a method and a control unit for triggering passenger protection devices, at least one characteristic is extracted from at least one variable. A crash is classified on the basis of this at least one characteristic, and the crash classification results in the making of a triggering decision. The passenger protection devices are then triggered as a function of the triggering decision. The triggering decision is made by providing a sequence control which, as a function of at least one progression variable, activates or deactivates a plurality of functions for the crash classification and/or defines which at least one characteristic is used for the particular function.

### FIELD OF THE INVENTION

The present invention relates to a method and a control unit for triggering a passenger protection device.

### BACKGROUND INFORMATION

DE 102 52 227 has already described a method for triggering a restraining device. After detection of an impact, crash phases that are defined in time are predefined, and a crash type and a crash severity are determined for each crash phase on the basis of the signal. The corresponding restraining device(s) are triggered as a function of the severity and/or type of crash.

### SUMMARY

The method according to example embodiments of the present invention and the control unit according to example embodiments of the present invention for triggering passenger protection devices having the features described herein have the advantage over the related art that through the sequence control, which, as a function of a progression variable, activates or deactivates a plurality of functions for the crash classification and/or defines which at least one characteristic is used for the particular function, a better arrangement is provided for taking into account that a crash classification is a time-variant process. Some crashes require very rapid deployment, whereas more time remains for other classifications. For example, a triggering decision for a rapid impact against a hard obstacle must be made after just approximately 10 ms to 12 ms. For a slow impact against a yielding obstacle, however, it is not necessary to make a triggering decision within such a short period of time. Therefore, the decision between a crash against a yielding obstacle and no crash against a yielding obstacle may thus be made later during the crash than the decision between hard impact versus no hard impact. A manner of making this decision in a time-variant manner is by virtue of the sequence control which, with the help of the method and control unit according to example embodiments of the present invention, ensures that functions for the crash classification are activated or deactivated as a function of a progression variable or different characteristics for the functions are used as a function of the progression variable. With regard to the characteristics, this means that they are also activated or deactivated and thus there is a gain in resources. Time slices or state machines may also be used for this purpose.

Through a flexibilization of the algorithm decision-making process, it is possible to save on classification computation time which can be used for other calculations, e.g., for the fusion of various additional functions. Another advantage is the reduction in running time, which is reflected in the simpler hardware, which is thus less expensive. Furthermore, it is possible to respond in a more flexible manner to events during the crash because many triggering decisions are made only at a later time.

Passenger protection devices include both active and passive passenger protection devices. These include airbags, seat-belt tighteners, crash-activated head restraints, roll bars and pedestrian protection devices but also interventions in the vehicle dynamics. In the present case, mainly sensor signals from all accident-relevant sensors in a vehicle may be considered as at least one variable, including in particular deceleration sensors, structure-borne noise sensors, air pressure sensors, contact sensors and surroundings sensors. It is also possible to use measurable and immeasurable variables which are calculated in other control units such as in the ABS/ESP control unit or the ACC control unit. This may be advantageous in multiple crashes in particular: after an initial collision that is less severe, the vehicle skids at a 90° slip angle, which is calculated in the ESP control unit. The side collision algorithm may then be deactivated for the side collision plausibility check because the variable of slip angle=90° already provides plausibility. The time saved may be provided for other functions, as indicated above.

For example, the filtered sensor signal, a sensor signal integrated once, twice or three times, a sensor signal average, a window integral, derivations of a variety of types, sums, etc., may be used as the characteristic. Likewise, a wide variety of types of filtering are also possible. Extraction of the characteristic is accomplished through these methods. If the characteristics are activated and deactivated, the determination of the deactivated characteristics may be omitted, which thus saves on computation time.

Crash classification is the procedure whereby the crash that occurs is classified in a class. Such classes include, for example, hard frontal crash, soft frontal crash, hard side crash, offset crash, etc., which may be divided into any gradations. With this classification, it is then possible to trigger suitable passenger protection devices.

The sequence control may be arranged according to example embodiments of the present invention as a software module or as a hardware element. The sequence control ensures that the majority of functions for the crash classification are activated or deactivated as a function of at least one progression variable. The sequence control is therefore to be understood in the sense of a controller.

The functions are intended for performing these different crash classifications. Example embodiments of the present invention make it possible for only the required functions to be calculated at predefined times or events. This means efficient utilization of existing resources.

An interface is understood to be an interface unit implemented in either hardware or software. A combination of hardware and software may also be used to provide the interface. If the interface is implemented only in hardware, it is possible to construct it using discrete elements, integrated elements or a combination of discrete and integrated elements. In an integrated approach, it is also possible to use multiple integrated circuits. The interface may in particular have multiple data inputs and also multiple data outputs. An analyzer circuit is usually understood to be a microcontroller or another processor. However, simpler circuits which may be arranged in the form of ASICs are also possible. A discrete approach is also possible. A triggering circuit is understood to be such a circuit that ensures activation of the passenger protection devices. With passive protection devices, this triggering circuit has in particular power switches which are switched through as a function of the trigger signal. For the triggering circuit it is also possible to provide a discrete or integrated approach. A mixture thereof is also possible in the present case. In the case of an integrated approach, it is also possible to provide multiple integrated modules.

Advantageous improvements on the method and control unit for triggering passenger protection devices described below are possible through the measures and refinements described below.

It is advantageous in particular that the at least one progression variable is a time after the start of the crash or the at least one characteristic or another event. A combination of these possibilities is also possible. This control via the progression variable allows adaptation to certain accident processes in a particularly effective manner. This permits an even better protective effect for the vehicle occupants and also others involved in the accident.

In addition, it is advantageous that when the progression variable has a discontinuity, it is replaced by a value that restores a monotonicity of the progression variable. This permits a stable sequence control with respect to activation and deactivation of functions.

In addition, it is advantageous that the event is an error state of a sensor system of a control unit or of a passenger protection system. Such events may thus also be included in the determination of the crash classification in particular.

Exemplary embodiments of the present invention are depicted in the drawings and explained in greater detail in the following description.

### BRIEF DESCRIPTION OF THE DRAWINGS

FIG. 1 shows a block diagram of the control unit according to example embodiments of the present invention including connected components,

FIG. 2 shows a selection of software modules on the microcontroller of the control unit,

FIG. 3 shows a flow chart of the method according to example embodiments of the present invention,

FIG. 4 shows a block diagram of the sequence control,

FIG. 5 shows a first example of a time-controlled sequence control,

FIG. 6 shows a second example of a time-controlled sequence control, and

FIG. 7 shows an example of an event-controlled sequence control.

### DETAILED DESCRIPTION

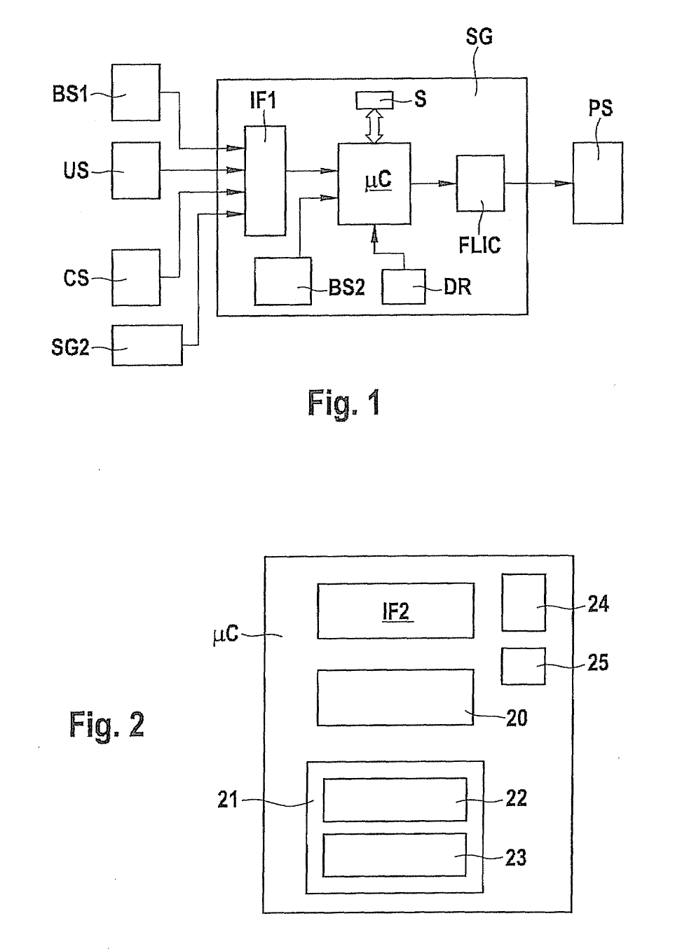

FIG. 1 shows a block diagram of control unit SG according to example embodiments of the present invention having connected components. As an example, only the elements of the control unit necessary for understanding example embodiments of the present invention are shown around the corresponding connected components. The control unit has other components that are necessary for operation of control unit SG. For the sake of simplicity, they have been omitted in the present case.

Three external sensor systems BS1, US and CS and, for example, another control unit SG2, which in the present case is the control unit for electronic stability control, are connected to control unit SG. In addition, control unit SG may process variables measured and processed by at least one other control unit and made available to the control unit. For example, acceleration sensor system BS1 is situated in a sensor cluster, in the vehicle sides, in the area of the vehicle front, behind the bumper. Acceleration sensor system BS1 therefore has a sensor element, usually manufactured micromechanically, which outputs a signal, which may be analyzed electrically as a result of a deceleration, and is then amplified and digitized. This digital signal is then transmitted to interface IF1 and control unit SG. Interface IF1 is implemented in hardware in the present case. It is in the form of an integrated circuit in the present case. A surroundings sensor system US, which may be a radar, lidar, ultrasonic, video and/or infrared sensor system, is also connected to interface IF1. The sensor system may have individual ones of these sensors or combinations thereof. These sensors are usually installed in the vehicle front or in the vehicle trunk. Other installation sites are also possible in the present case. Here again, the surroundings sensor system has a surroundings sensor element, e.g., an ultrasonic sensor or radar sensor or image sensor and a connected signal conditioner and, if necessary, also a signal processor, which then transmits the signal digitally to interface IF1. In addition, an accident sensor system CS having other accident sensors, e.g., a structure-borne noise sensor system, an air pressure sensor system or a contact sensor system, is also connected to interface IF1. With regard to these sensors, accident sensor system CS also has corresponding sensing elements, amplifies these signals and transmits them digitally to interface IF1. It is possible that only acceleration sensor system BS1 or only surroundings sensor system US or only accident sensor system CS is connected to interface IF1. Any combination of these sensors is also possible. Control unit SG2 transmits calculated variables such as a side impact plausibility, which was determined by the slip angle. Other variables are also possible.

Interface IF1 converts the received sensor data into a format suitable for microcontroller μC and then transmits the signals to microcontroller μC for further processing. For example, interface IF1 uses for this purpose the so-called SPI bus, i.e., the serial peripheral interface bus, which may be used for the transmission of data in the control unit and microcontroller. Parallel processing of the sensor data by a safety module is not shown because it is not necessary for an understanding of example embodiments of the present invention.

In the present case, however, two other sensor systems are also present in control unit SG itself, namely an acceleration sensor system BS2 capable of picking up decelerations in different sensitivity directions, and a rotational rate sensor system DR, which may also have different sensitivity axes. These sensor systems BS2 and DR that are internal within the control unit may be connected to analog inputs of microcontroller μC, but it is also possible for them to be connected to digital ports of microcontroller μC instead, in order to output a digital signal, for example.

Microcontroller μC is connected via a data input/output to a memory S, from which it is able to load its analysis algorithm and other functions. Microcontroller μC may also use this memory as a working memory. Memory S may include a memory module or a plurality of memories of different designs. Microcontroller μC has a software interface via which it supplies the signals of internal sensors BS2 and DR within the control unit. The characteristics are then extracted from the sensor signals, e.g., as indicated above, the sensor signal integrated once, e.g., in a time window. This characteristic is then analyzed by a threshold comparison to determine whether passenger protection devices may be triggered. To do so, however, a crash classification must also be performed. A sequence control is now provided for this purpose according to example embodiments of the present invention, which for example as a function of time as the progression variable activates and deactivates functions used for crash classification. Through this efficient sequence control, resources with regard to the microcontroller and its memory S are saved and the run time is increased. If microcontroller μC comes to the conclusion that a triggering decision has been made, then it generates a trigger signal and transmits it to triggering circuit FLIC. This triggering circuit FLIC, which includes a plurality of integrated modules in the present case, ensures activation of passenger protection device(s) PS as a function of this trigger signal. If these are passenger protection devices that are activatable pyrotechnically, e.g., airbags or seat-belt tighteners, then the ignition elements for these passenger protection devices are energized, thus resulting in explosions which activate the passenger protection devices.

FIG. 2 illustrates schematically the relevant software modules which microcontroller μC may have. Second interface IF2 which is provided for supplying the sensor signals of acceleration sensor system BS2 and rotational rate sensor system DR is labeled here as IF2. Another software module 20 extracts the at least one characteristic, e.g., an integrator. The crash classification is provided in block 21. This has a sequence control 22 and a function pool 23 itself, the functions of the sequence control being activated or deactivated as a function of the progression variable. A crash is classified by crash classification 21 and thus the triggering decision about which passenger protection devices are to be triggered is then made in module 24. The corresponding trigger signal for this is then generated by module 25. This module 25 then ensures a transfer to triggering circuit FLIC.

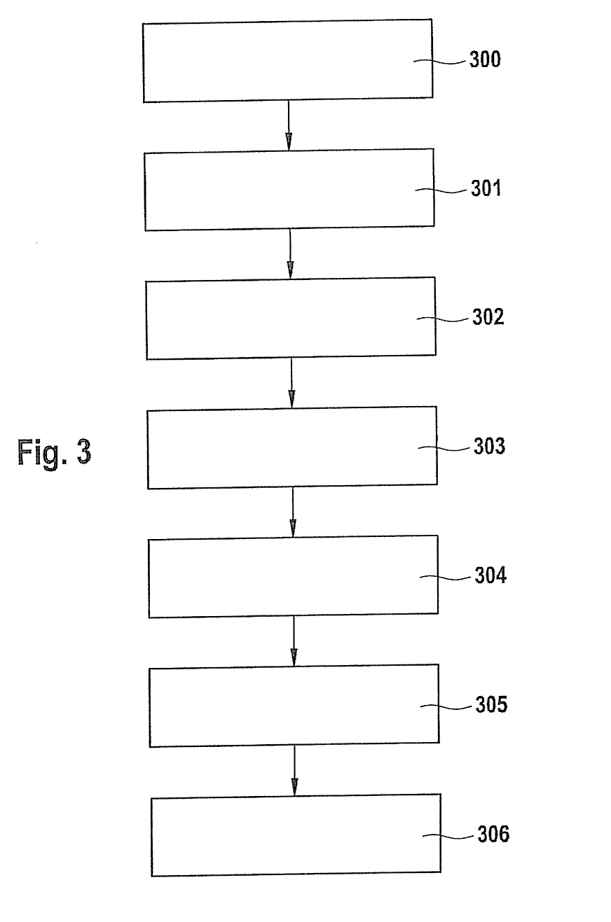

FIG. 3 illustrates the sequence of the method according to example embodiments of the present invention in a flow chart. The at least one sensor signal or the previous classification result or another progression variable is supplied in method step 300. In method step 301, the at least one characteristic is extracted in the manner described above from the at least one sensor signal or the at least one progression variable or the at least one previous classification result. In method step 303, activation and deactivation of the functions and activation and deactivation of the characteristics needed for the crash classification are then performed by sequence control 302. The sequence control is then performed, e.g., as a function of time, starting from the start of the crash, whereby exceeding a noise threshold, for example, may be regarded as the start of the crash, the noise threshold being approximately 1.5 to 4 g. In method step 304, the crash classification is then performed by the individual functions. As a function of this crash classification, the triggering decision is then made in method step 305. This decision includes not only whether or not passenger protection devices are triggered, but also which and, if so, how strongly. In method step 306, the triggering is then performed as a result of the trigger signal transmitted to the triggering circuit.

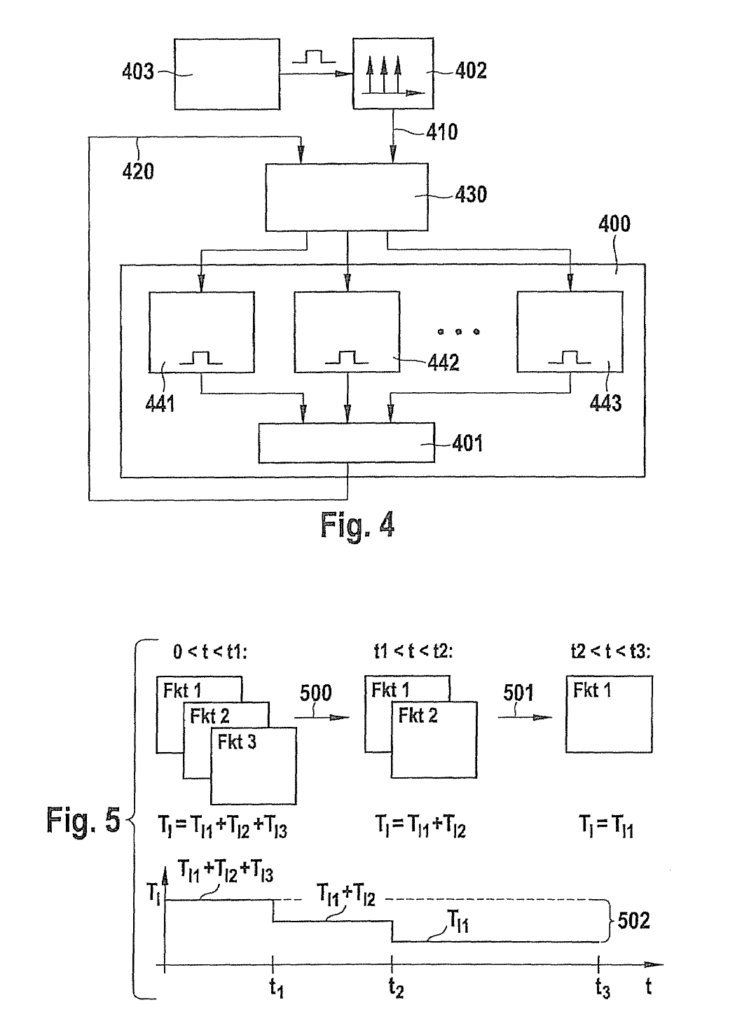

FIG. 4 shows a flow chart for the sequence control. The start of the crash is detected in block 403 by a noise threshold being exceeded. A timer 402 is then activated. This timer transmits a start signal 410 to a controller 430. Controller 430 is the central element of the sequence control. Controller 430 activates or deactivates the functions of function pool 400. This shows as an example three functions 441, 442 and 443 that are used for different crash classifications. In the present case, controller 430 controls the activation and deactivation of the individual functions as a function of time from the start of the crash. Control as a function of other progression variables or a combination of progression variables or previous classification results is also possible in the present case.

Functions 441, 442 and 443 then ensure classification 401 of the present crash and other functions may also be present.

FIG. 5 shows an exemplary embodiment of a time control of the sequence according to the present invention. Instead of time control, the first or second integral of the acceleration or any other monotonized variable could also be used.

As shown in FIG. 4, the present time in relation to the start of the crash is sent to controller 430 via 410. The start of the crash may be determined, for example, via a module that detects the noise threshold being exceeded. If more than t1 ms has elapsed since the start of the crash in a fast impact against a hard obstacle, as represented by t1 in FIG. 5, then there need not be any further deployment of the corresponding restraining device. In the same manner, all functions of function pool 400 that are needed for classification of a fast impact against a hard obstacle may be deactivated after t1. The deployment decision for a slow impact against a yielding obstacle must occur up until point in time t2 at the latest. Otherwise there must be no deployment. Similarly, all functions for classification of a slow impact against a yielding obstacle may be masked out for the types of crash occurring at point in time t3 or later.

FIG. 5 shows schematically the time-based algorithm processing described here. In addition, FIG. 5 also shows how run time Tₗ may be saved using the method described here. This gain in run time constitutes a significant advantage of the method described here with regard to saving costs due to simpler hardware. The example described here refers to a frontal crash. In principle, however, this method may also be applied to a side crash, rollover crash, pedestrian crash or rear end crash or a combination of these types of crashes.

FIG. 5 shows three intervals characterized by activation and deactivation of various functions. Until point in time t1, functions 1, 2 and 3 are activated. This yields a total run time of Tₗ=Tₗ₁+Tₗ₂+Tₗ₃ for the microcontroller. As explained above, the start of the crash is at point in time t1. Therefore, transition 500 is deleted by controller 430, function 3. Thus Tₗ=Tₗ₁+Tₗ₂ is provided as the run time in time interval t1 through t2. In next transition 501 for time interval t2 through t3, controller 430 deletes function 2, so that the run time is reduced to Tₗ₁ for microcontroller μC. Run time gain 502 is thus detectable at point in time t3.

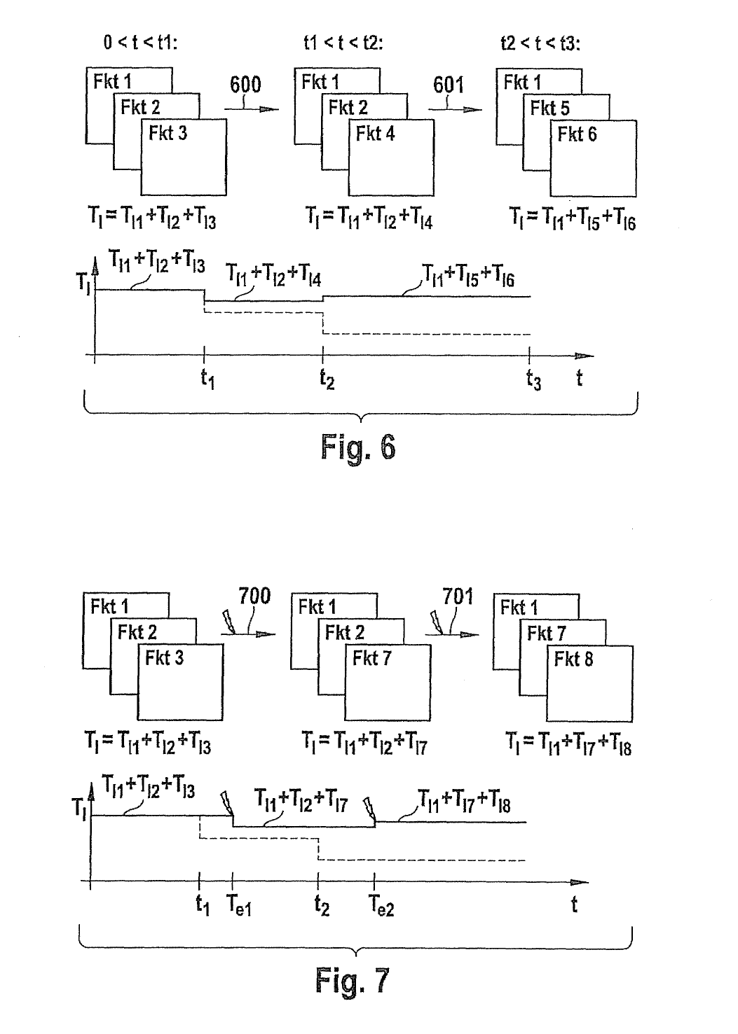

FIG. 6 shows another exemplary embodiment of the time control. Again, three functions 1, 2 and 3 are provided in interval 0 through t1, so that the run time is obtained as the sum of Tₗ₁, Tₗ₂ and Tₗ₃ accordingly. In the transition to the next time interval between t1 and t2, which is labeled here with reference numeral 600, controller 430 replaces function 3 with function 4. The run time therefore changes accordingly as the sum of Tₗ₁, Tₗ₂ and Tₗ₄. In the transition to the next time interval between t2 and t3, which is labeled with reference numeral 601, controller 430 replaces functions 2 and 4 with functions 5 and 6. Accordingly, the run time is Tₗ₁+Tₗ₅+Tₗ₆.

Signal path 420 from FIG. 4 includes a classification result from the last classification interval. On the basis of this existing classification, controller 430 makes the decision about which functions of function pool 400 are to be additionally activated and which may be deactivated.

FIG. 7 illustrates the method taking into account the run time. For example, at point in time Tₑ₁, it is possible on the basis of the previous classification result to rule out that it is a fast crash against a hard obstacle. On the basis of this event 1, all functions that are used for classification of fast crashes against hard obstacles may then be deactivated. In FIG. 7, this would be function 3, for example. On the other hand, a function that helps in the separation of slow crashes against a yielding barrier from the same type of crash having an angular component could then be loaded on the basis of the increase in run time. This might be function 7 illustrated in FIG. 7. For the latter, deployment would usually take place later. At a later point in time Tₑ₂, for example, the crash is classified as not being a slow crash having an angular component against a yielding barrier. For this reason, function 2 could be deactivated. To obtain a better separation of slow crashes against a yielding barrier, for example, and slow crashes against a partly covered yielding barrier, function 8 could therefore be loaded as an alternative on the basis of event 2 at point in time Tₑ₂.

Both points in time Tₑ₁ and Tₑ₂ are determined exclusively by the classification results from the previous classification interval. They do not coincide with the time-controlled sequence from the previous figures. The example described here refers to a frontal crash. In principle, other crash results or rollover results may also be applied.

The run times show a corresponding trend here. A time-controlled curve is represented by dashed lines and the event-controlled curve is represented by solid lines. Three functions 1, 2 and 3 are active in the first time interval up to Tₑ₁ so that the run time is obtained as the sum of run times accordingly, i.e., Tₗ₁+Tₗ₂+Tₗ₃. At transition 700 triggered by the event, where a fast crash against a hard obstacle may now be ruled out, controller 430 replaces function 3 with function 7. The run time changes accordingly, so that the total run time is obtained from Tₗ₁+Tₗ₂+Tₗ₇. At point in time Tₑ₂ another event occurs, namely a slow crash against a soft obstacle may be ruled out. In transition 701, controller 430 then replaces function 2 with function 8. Consequently, the run time is now the sum of Tₗ₁+Tₗ₇+Tₗ₈.

1-5. (canceled)

6. A method for triggering passenger protection devices, comprising:
extracting at least one characteristic from at least one variable;
making a triggering decision as a function of a crash classification, the crash classification being performed as a function of the at least one characteristic; and
triggering the passenger protection devices as a function of the triggering decision;
wherein the triggering decision is made by providing a sequence control which, as a function of at least one progression variable, at least one of (a) at least one of (i) activates and (ii) deactivates a plurality of functions for the crash classification and (b) defines which at least one characteristic is used for the particular function.

7. The method according to claim 6, wherein the at least one progression variable is at least one of (a) a time after a start of the crash, (b) the at least one characteristic, and (c) an event.

8. The method according to claim 7, wherein a discontinuity in at least one progression variable is replaced by a value that establishes a monotonicity of the progression variable.

9. The method according to claim 7, wherein an error state of a sensor system of at least one of (a) a control unit and (b) a passenger protection system is used as the event.

10. A control unit for triggering passenger protection devices, comprising:
an interface adapted to provide at least one variable;
an analyzer circuit adapted to perform a crash classification as a function of at least one characteristic derived from the at least one variable and to make a triggering decision as a function of the crash classification, the analyzer circuit having a sequence control, the sequence control adapted to at least one of (a) at least one of (i) activate and (ii) deactivate a plurality of functions as a function of at least one progression variable and (b) define which at least one characteristic is used for the particular function; and
a trigger circuit adapted to trigger the passenger protection devices as a function of a trigger signal from the analyzer circuit.
